(19) United States
(12) Patent Application Publication
(10) Pub. No.: US 2017/0318022 A1
(43) Pub. Date: Nov. 2, 2017

(54) PROTECTION OF RESOURCE INFORMATION BASED ON DYNAMIC ASSIGNMENT OF RESOURCES IN A WIRELESS NETWORK

(71) Applicant: Nokia Solutions and Networks Oy, Espoo (FI)

(72) Inventors: Eva Perez, München (DE); Christian Markwart, München (DE)

(21) Appl. No.: 15/522,417

(22) PCT Filed: Nov. 3, 2014
(86) PCT No.: PCT/EP2014/073581

§ 371 Date: Apr. 27, 2017

(51) Int. Cl. H04L 29/06; H04W 12/10

(52) U.S. Cl. CPC H04L 63/102; H04W 12/10; H04L 63/06; H04L 63/107

(57) ABSTRACT

An example technique may include determining a change in an assignment state for a network resource that is shared among a plurality of sharing partners in a wireless network, and determining, for one or more of the sharing partners, information access authorization for access to the resource information related to the network resource based on the determining the change in assignment state for protecting the resource information.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations, which are referred to as enhanced Node Bs (eNBs), provide wireless access within a coverage area or cell. In LTE, mobile devices, or mobile stations are referred to as user equipments (UE). LTE has included a number of improvements or developments.

### SUMMARY

According to an example implementation, a method may include determining a change in an assignment state for a network resource that is shared among a plurality of sharing partners in a wireless network, and determining, for one or more of the sharing partners, information access authorization for access to the resource information related to the network resource based on the determining the change in assignment state for protecting the resource information.

According to another example implementation, an apparatus may include at least one processor and at least one memory including computer instructions, when executed by the at least one processor, cause the apparatus to: determine a change in an assignment state for a network resource that is shared among a plurality of sharing partners in a wireless network, and determine, for one or more of the sharing partners, information access authorization for access to the resource information related to the network resource based on the determining the change in assignment state for protecting the resource information.

According to another example implementation, a computer program product may include a computer-readable storage medium and storing executable code that, when executed by at least one data processing apparatus, is configured to cause the at least one data processing apparatus to perform a method including: determining a change in an assignment state for a network resource that is shared among a plurality of sharing partners in a wireless network, and determining, for one or more of the sharing partners, information access authorization for access to the resource information related to the network resource based on the determining the change in assignment state for protecting the resource information.

According to another implementation, an apparatus may include means for determining a change in an assignment state for a network resource that is shared among a plurality of sharing partners in a wireless network, and means for determining, for one or more of the sharing partners, information access authorization for access to the resource information related to the network resource based on the determining the change in assignment state for protecting the resource information.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram illustrating a mutual renting of resources according to an example implementation.

FIG. 3 is a diagram illustrating a limited spectrum pool according to an example implementation.

FIG. 4 is a block diagram of a dynamic sharing system 400 according to an example implementation.

FIG. 5 is a flow chart illustrating operation of a resource management system according to an example implementation.

FIG. 6 is a block diagram illustrating operation of a dynamic sharing system 400 for a limited spectrum (or resource) pool mode of dynamic sharing according to an illustrative example implementation.

FIG. 7 is a block diagram illustrating operation of a dynamic sharing system 400 for a mutual renting mode of dynamic sharing according to an illustrative example implementation.

FIG. 8 is a block diagram of a wireless station (e.g., BS or user device) according to an example implementation.

### DETAILED DESCRIPTION

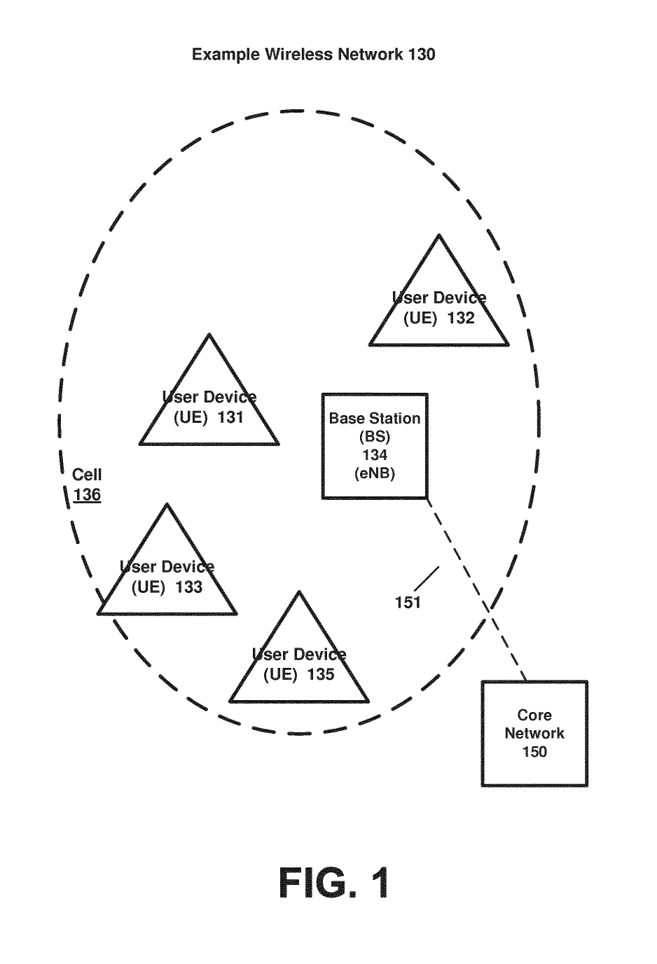

FIG. 1 is a block diagram of a wireless network 130 according to an example implementation. In the wireless network 130 of FIG. 1, user devices 131, 132, 133 and 135, which may also be referred to as user equipments (UEs), may be connected (and in communication) with a base station (BS) 134, which may also be referred to as an enhanced Node B (eNB). At least part of the functionalities of a base station or (e)Node B (eNB) may be also be carried out by any node, server or host which may be operably coupled to a transceiver, such as a remote radio head. BS 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station, a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

According to an example implementation, wireless resources (or network resources) may be dynamically shared among a plurality of sharing partners. A wireless or network (or spectrum) resource may generally include time, frequency, and/or code resources that may be defined for a particular area or space. For example, a resource may include one or more wireless physical resource blocks (PRBs) defined by a particular frequency or frequency range and time(s). According to an example implementation, each PRB may include M (e.g., 12) subcarriers by N (e.g., 7) orthogonal frequency division multiplexing (OFDM) symbols. This is merely one illustrative example, and other resources may be provided, or resources may be allocated in different manners.

According to an example implementation, a sharing partner may be a wireless entity that may share wireless/spectrum resources with other sharing partners and/or a wireless entity that may obtain wireless/spectrum resources from other sharing partners. A sharing partner may also typically provide wireless services to one or more user devices based on these resources, e.g., via one or more base stations, eNBs, device-to-device mode, or other wireless network.

According to an illustrative example implementation, wireless resources may include licensed shared access (LSA) spectrum, which may also be known as authorized shared access (ASA) spectrum that may be used to extend the capacity for broadband wireless access. A LSA spectrum may be owned by an incumbent (or owner), who may allow other licensed operators (e.g., mobile network operators) to use this spectrum for their purpose. In LSA, one or more operators may be licensed by a regulator (where the operator may then be referred to as a licensee) to share or obtain spectrum/network resources from incumbents or other licensees. An LSA spectrum may include multiple LSA spectrum resources (or network resources), where each spectrum resource may, for example, be defined by a spectrum (e.g., a frequency, or frequency band), a location where the spectrum is used, and a time when the spectrum is used at the location/area. In one illustrative example implementation, a spectrum (or network) resource may include M subcarriers by N OFDM symbols, although this is only one illustrative example.

In many mobile/wireless networks, spectrum (or resource) allocation and utilization is typically provided in a static manner, where resources are allocated to one operator and then used by that operator to provide wireless services. In a static resource allocation, each spectrum/resource may typically be exclusively allocated by a regulator (or other government entity) to one operator.

According to an example implementation, resources may be dynamically shared among multiple sharing partners (e.g., among multiple operators, licensees, or other wireless entities that may share or obtain resources and/or may provide wireless services). For example, in a dynamic sharing of spectrum/network resources, resources may be initially assigned to an incumbent or an initial sharing partner. One or more dynamic sharing modes may be used to share one or more of these resources with one or more sharing partners. Two example dynamic sharing modes may include mutual renting and limited spectrum pool.

According to an example implementation, in a mutual renting mode or scenario, spectrum resources in a band are subdivided into several blocks and each block is assigned to one sharing partner or operator. Sharing partners may temporarily re-assign (or “rent”) resources (or spectrum blocks) to one or more other sharing partners, e.g., upon request. A sharing partner may rent resources from multiple other sharing partners simultaneously. Also, an owner or incumbent of a resource may typically have strict priority in accessing its resource, including the ability to evacuate the resource or to pre-empty any partners that may be using the resource. For example, in mutual renting, a government entity may be the incumbent or owner of the resource. The owner/incumbent may initially assign the resource to a sharing partner or operator. The sharing partner may temporarily re-assign (or rent) such resource to other sharing partners or operators.

According to another example implementation, in a limited spectrum pool mode or scenario, resources are not exclusively assigned to an operator or sharing partner. Rather, in a limited spectrum pool, the resources may be placed in a pool of resources, where each resource in the pool may be assigned to a sharing partner. A limited number of sharing partners (e.g., operators or licensees) have authorization to use spectrum (or network) resources in the pool of resources up to a specific amount, e.g., up to a band of resources or the entire spectrum of resources. For example, a minimum and/or maximum amount of resources assigned from the pool of resources to each sharing partner may be defined via a fairness policy.

The dynamic sharing modes of limited spectrum pool mode and mutual renting mode are two illustrative examples of sharing modes to dynamically share resources. These are merely two examples, and other modes of dynamic sharing of resources may be used. Likewise, the terms Regulator, Incumbent (or owner) and Licensee are roles or functions that may be mapped to or performed by a number of different network entities or participants of any sharing method, and or one or more of these roles or functions described herein may be identified using a different name or term. In some sharing methods, one or more of these roles or functions, e.g., Regulator, Incumbent, Licensee, etc. (or other roles or functions described herein), may not necessarily participate or play a role in a dynamic sharing method, or the role or function may be different than what is described in the illustrative examples described herein, since the two dynamic sharing modes described herein are merely examples.

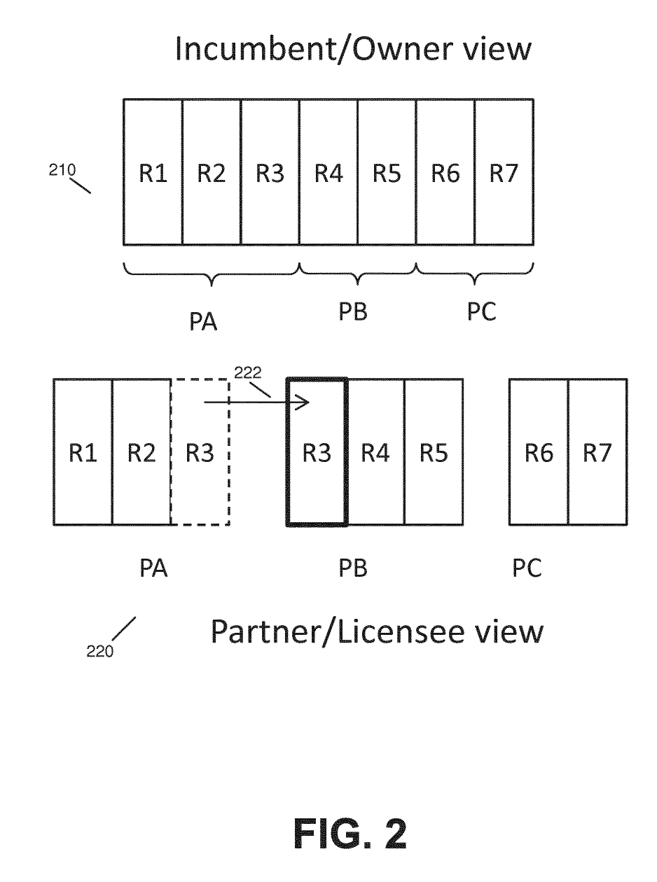

FIG. 2 is a diagram illustrating a mutual renting of resources according to an example implementation. An incumbent/owner view 210 of the resources shows that resources R1, R2 and R3 have been initially assigned (e.g., by the owner) to sharing partner A (PA), resources R4 and R5 have been initially assigned to sharing partner B (PB), and resources R6 and R7 have been initially assigned to partner C (PC). The sharing partner (or operator or licensee) view 220 of the resources shows that resources R1, R2 and R3 are initially assigned to sharing partner A (PA), resources R4 and R5 are initially assigned to PB, and resources R6 and R7 are initially assigned to PC. As shown by the arrow 222, sharing partner A (PA) temporarily re-assigns (or rents) resource R3 to sharing partner B (PB). However, this renting of resource R3 may not be known by the owner of resource R3. As shown in FIG. 2, the renting of R3 is not reflected in the incumbent/owner view 210 of the resources.

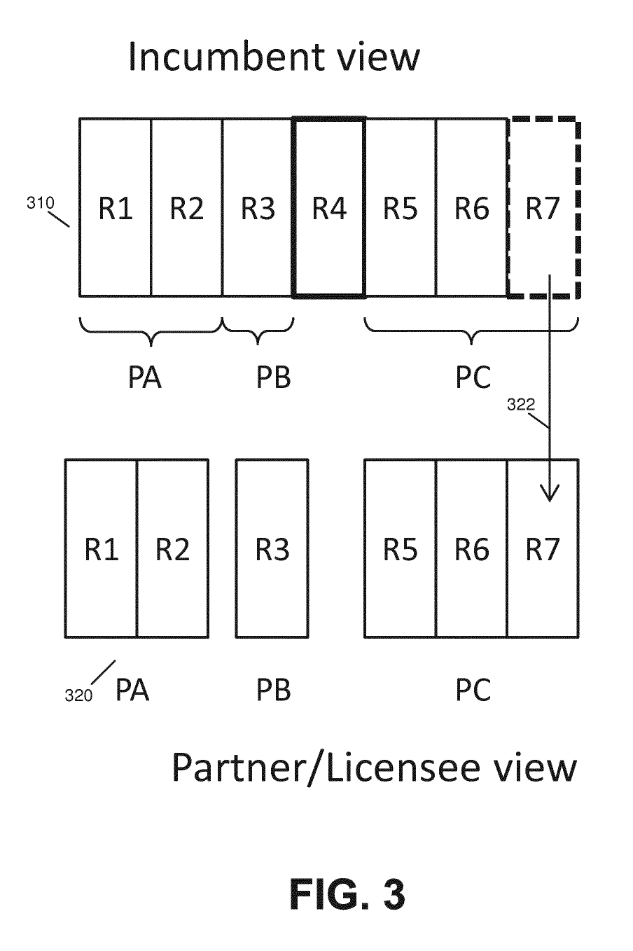

FIG. 3 is a diagram illustrating a limited spectrum pool according to an example implementation. An incumbent/owner view 310 and a sharing partner view 320 of resources. Resources R1-R7 are placed in a pool of resources, which may be assigned to a limited number of sharing partners (e.g., operators or licensees). Initially, resources R1 and R2 are assigned to sharing partner A (PA), resource R3 is initially assigned to sharing partner B (PB), and resources R5 and R6 are initially assigned to sharing partner C (PC). Resource R4 is not assigned to any sharing partner (thus, R4 only appears in the incumbent/owner view 310). In one illustrative example, sharing partner C (PC) may submit a request for an additional resource, and resource R7 is then assigned to PC, as shown by line 322.

Several issues may arise as a result of the dynamic sharing of resources. First, for example, in some cases, it may be more difficult for the owner of R3 to evacuate R3 or to pre-empt the current assignee/user of R3 (which would be PB in this case), since the re-assignment of R3 to PB is not known to the incumbent/owner or R3. Thus, at the very least, this renting of R3 may introduce additional delay into the evacuation of resource R3, since, for example, the owner may first need to obtain the identity (from PA) of the current assignee (PB), and then contact the current assignee (PB) to instruct PB to evacuate R3 (e.g., relinquish R3 and/or cease using R3). Second, a dynamic sharing of resources (e.g., mutual renting, limited spectrum pool or other dynamic sharing mode or technique) raises the issue of which sharing partner(s) should be given access to resource information related to various resources, such as resource information related to resource R3 in this example.

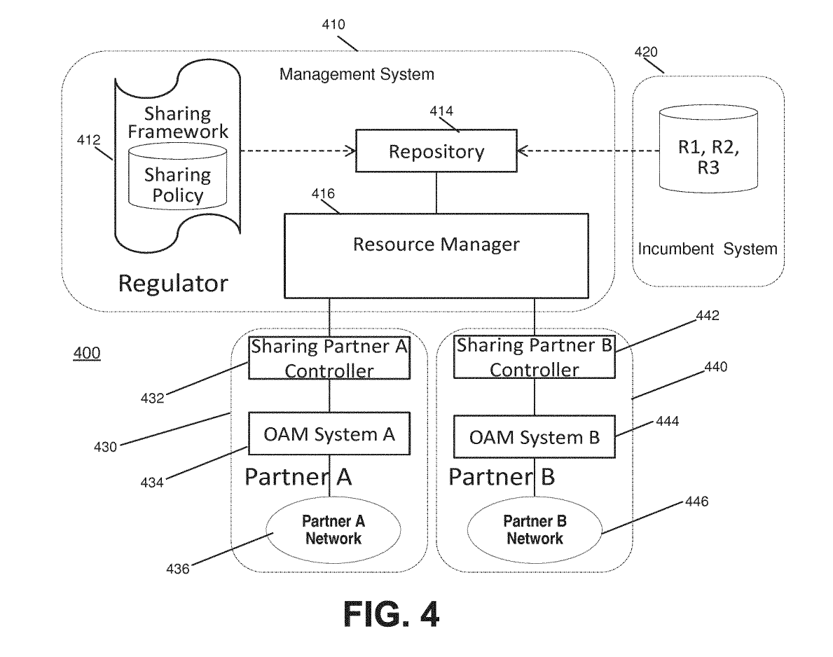

FIG. 4 is a block diagram of a dynamic sharing system 400 according to an example implementation. Dynamic sharing system 400 may include a management system 410, an incumbent/owner system 420, a sharing partner A system 430, and a sharing partner B system 440.

Incumbent (owner) system 420 may own one or more resources, e.g., resources R1, R2, R3. Various information related to each resource, such as resource definitions, resource availability, etc., may be provided to a repository 414 from incumbent/owner system 420. Incumbent/owner system 420 may also submit a request to evacuate a resource to repository 414 and/or to resource manager 416, which may cause resource manager 416 to send one or more messages to a sharing partner to which a resource is currently assigned. Alternatively, Incumbent/owner system 420 may obtain, from resource manager 416, the (identify of) the sharing partner to which a resource is currently assigned, and then incumbent system 420 may send a message to the currently assigned sharing partner requesting evacuation of the resource.

Within dynamic sharing system 400 (FIG. 4), a system may be provided for each sharing partner, including, for example, a partner A system 430 for sharing partner A and a partner B system 440 for sharing partner B. These are merely examples, and other systems for other sharing partners may be provided. Partner A system 430 may include, for example, a controller 432 (which may include a processor, memory, a network interface), a partner A wireless network 436 (which may include base stations and other network equipment or network infrastructure), an operation and maintenance (OAM) system 434 for managing the wireless network 436. The other systems for each of the other sharing partners may be the same or very similar to the partner A system 430 for partner A. For example, the partner B system 440 for sharing partner B may include a sharing partner B controller 442, a OAM system 444 and a partner B wireless network.

In an illustrative example implementation, for sharing partner A, a sharing partner A controller 432 may request and obtain one or more resources from resource manager 416, e.g., via a message sent to resource manager (or exchange or messages with resource manager) such as for limited spectrum pool, or via a communication or exchange of messages with another partner system (e.g., partner B system 440) such as for mutual renting. OAM system A 430 may configure or otherwise setup partner A network 436 to use to use the resources for use by partner A network 436. Partner A network 436 may provide wireless services to one or more wireless customers or users via the obtained wireless resources, for example. Other sharing partner systems may similarly obtain resources, and then use the resources to provide wireless services to users or customers.

Management system 410 (FIG. 4) may include a sharing framework 412, including a sharing policy (which may include a fairness policy). The sharing policy may describe sharing rules, and usage and restriction requirements for one or more network resources, and may include a fairness policy/rules that define fairness rules for resource usage. For example, a fairness policy may define a maximum amount of resources that may be assigned from a limited spectrum pool to any of the sharing partners at one time, for example. For example, according to the fairness rules a maximum of 60% of the resources in a spectrum pool may be assigned to any one sharing partner at any time. A sharing policy, which may be defined by a regulator or other entity, may be provided for each dynamic sharing mode, e.g., a first sharing policy for mutual renting, and a second sharing policy for limited spectrum pool.

Management system 410 may also include a repository 414 (or data storage or a database), which may include or store information, including: 1) an access policy for each of the plurality of dynamic sharing modes to define how information access authorizations should be updated based on an assignment state change for a resource (and/or based on other information); 2) resource information related to each of a plurality of network resources, and 3) information access authorizations for one or more network resources.

According to an example implementation, the information access authorizations may indicate whether or not each of one or more sharing partners is authorized to access one or more parameters (or portions) of the resource information related to a network resource. In one example implementation, the information access authorizations for a network resource may be updated based upon a change in assignment state for the network resource, e.g., in accordance with an access policy. A change in assignment state may occur, for example, when a resource is assigned to a sharing partner (e.g., via one of the dynamic sharing modes, such as mutual renting or limited spectrum pool) or de-assigned (unassigned) from a sharing partner (e.g., where the resource is no longer assigned to the sharing partner), for example.

Resource information related to a network resource may include, for example, one or more of the following: 1) a resource definition for the network resource (e.g., parameters that identify frequencies/frequency bands, bandwidth, codes, time, OFDM symbols, PRBs, etc. of the network resource); resource availability of the network resource (e.g., identifying when or where the resource is available); 2) a resource sharing policy (which may include resource sharing rules that may describe resource usage and restriction requirements, a fairness policy, etc., for a resource); 3) assignment states for the network resource, e.g., that may identify a sharing partner (if any) to which the resource is assigned; and, 4) incumbent information for the resource that identifies an owner or incumbent for the resource.

According to an example implementation, a portion of the resource information may be accessed by all (or multiple) sharing partners, while a portion (e.g., a different portion) of the resource information may be accessed by only specific sharing partners, such as the sharing partner to which a resource is currently assigned. An access policy for a resource, e.g., based on assignment state(s) for the resource, may identify or determine which sharing partners are authorized to access which portions or parameters of the resource information. Also, in an example implementation, an incumbent may always have access to all, or only a portion, of the resource information of a resource, depending on the access policy. For example, different access policies may dictate different access authorizations.

According to one illustrative example implementation, resource information may include basic information that may be accessed by all (or multiple) sharing partners, and restricted information that may be accessed only by specific sharing partner(s), such as the sharing partner to which the resource is currently assigned. For example, basic information may include, e.g., a resource definition, resource availability, and a resource policy for a resource. Also, for example, restricted information may include, e.g., identification of an incumbent/owner of a resource, identification of a sharing partner to which the resource is currently assigned, and/or assignment states for the resource. These are merely some example parameters that may be provided within basic information and restricted information, and other parameters may be used instead.

Resource manager 416 (FIG. 4) may provide overall control of management system 410. In one illustrative example implementation, resource manager 416 may perform a variety of functions or operations, including, for example, one or more of the following functions or operations:

1) Resource manager 416 may determine a change in assignment state(s) for one or more resources, such as determining that a resource has been assigned to or de-assigned from a sharing partner. The assignment or de-assignment of a resource to one or more sharing partners may occur via one of a plurality of dynamic sharing modes, such as, for example, via a spectrum (or resource) pool in which each of a plurality of sharing partners may obtain one or more network resources within the resource pool, or a mutual renting in which an owner or a first sharing partner may rent or temporarily assign a resource to a second sharing partner. In determining a change in assignment states, resource manager 416 may assign each resource to one of the sharing partners. For example, in response to a request from the sharing partner for the resource (e.g., spectrum pool mode), resource manager 416 may assign a resource to a sharing partner in response to receiving an indication that the resource has been rented (or temporarily assigned/re-assigned) to a second sharing partner (e.g., mutual renting), or may assign one or more resources to a sharing partner based upon a schedule (e.g., a resource assignment schedule).

2) Resource manager 416 may maintain assignment states for each resource, including a mapping of a resource(s) to an assigned sharing partner (if any), in the event that the resource is assigned to a sharing partner. Therefore, for example, resource manager 416 may update in repository 414 or other memory or database any changes in assignment states for one or more of the resources.

3) Resource manager 416 may receive requests, from one or more sharing partners, for one or more resources, such as a request for a resource in a limited spectrum pool. Resource manager 416 may determine if the resource is available, and/or whether a sharing policy (e.g., fairness policy) would allow or permit assignment of the requested resource to the requesting sharing partner. The resource manager 416 may then send a reply, e.g., either rejecting the request for the resource (e.g., if the resource is unavailable or a sharing policy would not permit assignment of the resource to the requesting sharing partner) or accepting the request (e.g., sending a reply accepting the request and indicating that the resource has been assigned to the requesting sharing partner).

4) Resource manager 416 may update information access authorizations for each network resource, e.g., based on an access policy, and/or based on a change in assignment state(s) for the resource. The information access authorizations for each (or one or more) resource(s) may be stored in repository 414, and updated as necessary, by resource manager 416.

5) Resource manager 416 may receive requests for resource information (or may receive requests for a portion, or one or more parameters, of the resource information) related to one or more network resources from one or more sharing partners. Resource manager 416 may determine whether the requesting sharing partner should be granted or denied access to the resource information (or the requested portion of the resource information) related to a network resource based on the information access authorizations (e.g., stored in repository 414) for the network resource. Resource manager 416 may then send a reply to the requesting sharing partner either rejecting/denying the request to access (or obtain) the resource information, or accepting the request to access or obtain the resource information (granting access to the resource information or portion thereof).

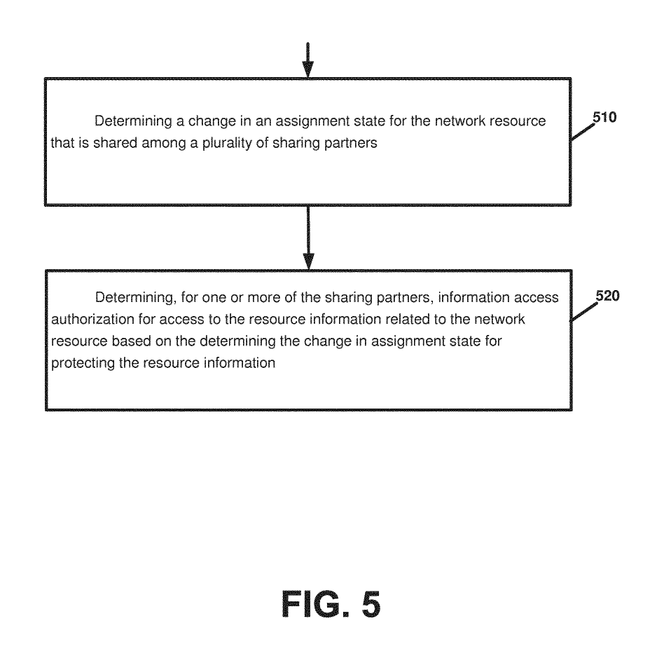

FIG. 5 is a flow chart illustrating operation of a resource management system according to an example implementation. Operation 510 may include determining a change in an assignment state for the network resource that is shared among a plurality of sharing partners in a wireless network. And, operation 520 may include determining, for one or more of the sharing partners, information access authorization for access to the resource information related to the network resource based on the determining the change in assignment state for protecting the resource information.

According to an example implementation of the method of FIG. 5, the determining information access authorization may include determining, for one or more sharing partners, whether the sharing partner is authorized or not to access at least a portion of the resource information.

According to an example implementation, the method of FIG. 5 may further include, for one or more of the sharing partners, either granting or denying access to one or more parameters of the resource information related to the network resource based on the determined information access authorization.

According to an example implementation of the method of FIG. 5, the determining information access authorization may include determining, for one or more sharing partners based on an access policy, an information access authorization for access to one or more parameters of the resource information based on the determined change in assignment state.

According to an example implementation of the method of FIG. 5 wherein the determining a change in assignment state comprises determining that the network resource has been assigned to a first sharing partner. The method may further include granting access to the first sharing partner to both basic information and restricted information of the resource information, and, denying access to one or more other sharing partners to at least the restricted information of the resource information.

According to an example implementation of the method of FIG. 5, the determining a change in assignment state(s) may include de-assigning the network resource to a first sharing partner and re-assigning the network resource to a second sharing partner. Also, the determining information access authorization may include determining that the second sharing partner is authorized to access at least a portion of the resource information and determining that the first sharing partner is not authorized to access at least a portion of the resource information. Also, the method further may include denying access to at least a portion of the resource information to the first sharing partner, and granting access to at least a portion of the resource information to the second sharing partner.

According to an example implementation of the method of FIG. 5, the determining a change in assignment state may include receiving an indication from a first sharing partner that the first sharing partner has rented or temporarily assigned the network resource to a second sharing partner. Also, the determining information access authorization may include determining that the first sharing partner is not authorized to access at least a portion of the resource information and determining that the second sharing partner is authorized to access at least a portion of the resource information. The method may further include one or more of the following: denying access to at least a portion of the resource information to the first sharing partner, and granting access to at least a portion of the resource information to the second sharing partner.

According to an example implementation of the method of FIG. 5, an access policy is provided for each of a plurality of sharing modes including a first access policy associated with a first sharing mode and a second policy associated with a second mode. Also, the determining information access authorization may include: determining that the first sharing mode is used for sharing the network resource among the plurality of sharing partners, determining that the first access policy is associated with the first sharing mode, and/or determining, for one or more sharing partners based on the first access policy, information access authorization for the access of the resource information based on the determined change in assignment state.

According to an example implementation of the method of FIG. 5, the plurality of sharing modes may include one or more of: a resource pool in which each of the sharing partners may obtain one or more network resources within the resource pool for a time period, and a mutual renting in which a first sharing partner may temporarily assign (or rent) a resource to a second sharing partner.

According to an example implementation, the method of FIG. 5 may further include updating in memory or a repository the change in the assignment state for the network resource.

According to an example implementation of the method of FIG. 5, the resource information related to the network resource may include one or more of the following: a resource definition for the network resource; resource availability for the network resource, resource sharing rules that describe usage and restriction requirements for the network resource, identification of an incumbent or owner of the network resource, and identification of a sharing partner, if any, to which the network resource is currently assigned.

According to an example implementation of the method of FIG. 5, a mutual renting mode may be used to share the network resource among the plurality of sharing partners, wherein the determining a change in assignment state may include receiving an indication from a first sharing partner that the first sharing partner has rented or temporarily assigned the network resource to a second sharing partner.

According to an example implementation of the method of FIG. 5, a resource pool mode may be used to share the network resource among the plurality of sharing partners, wherein the determining a change in assignment state may include at least one of: assigning the network resource to a first sharing partner, and de-assigning the network resource from the first sharing partner.

According to an example implementation of the method of FIG. 5, the determining a change may include: receiving a fairness policy for the assignment of the network resource; receiving, by a resource manager from a first partner, a request for the resource; retrieving the information related to the network resource; determining that the network resource is available; determining that the fairness policy allows assignment of the network resource to the first partner; and sending, from the resource manager to the first partner, a response indicating that the network resource has been assigned to the first partner.

According to an example implementation of the method of FIG. 5, the determining a change may include receiving an indication from a first partner that the first partner has rented or temporarily assigned the network resource to a second partner.

An apparatus may include means for carrying out the method according to any one of the operations described herein, including the operations related to FIG. 5.

A computer program product is provided for a computer, including software code portions for performing the steps of any of the operations described herein, including the operations related to FIG. 5, when product is run on the computer.

An apparatus comprising at least one processor and at least one memory including computer instructions, when executed by the at least one processor, cause the apparatus to: determine a change in an assignment state for the network resource that is shared among a plurality of sharing partners in a wireless network, and determine, for one or more of the sharing partners, information access authorization for access to the resource information related to the network resource based on the determining the change in assignment state for protecting the resource information.

A computer program product includes a computer-readable storage medium and storing executable code that, when executed by at least one data processing apparatus, is configured to cause the at least one data processing apparatus to perform a method including: determining a change in an assignment state for the network resource that is shared among a plurality of sharing partners in a wireless network; and determining, for one or more of the sharing partners, information access authorization for access to the resource information related to the network resource based on the determining the change in assignment state for protecting the resource information.

Some example details will now be described according to further illustrative example implementations of spectrum pool and mutual renting modes of sharing resources.

Sharing Via a Spectrum Pool (e.g. Limited Spectrum Pool):

1) According to an example implementation, a defined number of sharing partners (e.g., wireless operators) have access to a spectrum pool which includes a group of resources (e.g., network resources) and respective fairness policies for selection and assignment of the resources. Resource information is provided for each resource. In an example implementation, a regulator, e.g., a national Regulator, has issued an individual LSA license to each sharing partner or operator (which may then be referred to as a LSA Licensee), which allows sharing partner or licensee to participate at the sharing process.

2) Resource manager 416 assigns and de-assigns resources dynamically to requesting sharing partners (e.g., to requesting LSA Licensees) according to predefined resource sharing rules/policies. For example, only sharing partners or operators with a valid LSA License for the resource in the spectrum pool are allowed to issue requests for the resource, while others are blocked form requesting and/or receiving resources in the spectrum pool.

3) Relation between a resource and an assigned LSA Licensee (or a sharing partner to which a resource is assigned) is managed by the resource manager 416, e.g., the assignment state(s) for a resource. These assignment states for resources may be used to derive and configure respective information access authorization for the resource and the LSA Licensee (e.g., the information access authorizations identifying which sharing partner/LSA licensee may be permitted to access specific portions of the resource information for the resource). The information access authorizations may be stored either local at the resource manager 416 or external at a Repository 414. Additionally distributed storage on multiple systems is possible for optimizations.

4) The following additional management procedures may be part of the resource manager 416:
A) Incumbent as resource owner may typically always have information access authorization to access the (e.g., all of the) resource information for the resource.
B) When a resource is marked by the Incumbent as not available to a LSA Licensee/sharing partner, a request from a LSA Licensee for this resource is rejected by the resource manager 416. Only LSA Licensees that are assigned to the resource will get additional (e.g., restricted) information on the resource (e.g., information such as that a resource is reserved by Incumbent) according to their information access authorization.
C) When a resource is marked by Incumbent as available to a LSA Licensee/sharing partner and is not assigned to a LSA Licensee/sharing partner, a request from a LSA Licensee/sharing partner for this resource is analyzed by resource manager 416 and if accepted the resource is assigned to the requesting LSA Licensee/sharing partner. The decision process for the assignment of the resource may be steered via fairness policies, which may be based, for example, on national regulatory requirements for a defined sharing scenario/dynamic sharing mode.
D) When a resource is assigned to one LSA Licensee/sharing partner, the resource manager 416 grants access authorization to resource information related to the resource to the associated LSA Licensee/sharing partner, and the resource manager 416 ensures that other LSA Licensees/sharing partners have no access authorization to the resource information related to the resource. As long as the assignment is valid subsequent requests from other LSA Licensees/sharing partners for any of the resource information for the resource are rejected by the resource manager 416 and, e.g., no information on the resource is provided to other LSA Licensees or sharing partners.
E) When the resource is assigned to a LSA Licensee/sharing partner, and the LSA Licensee/sharing partner requests a de-assignment of this resource (e.g., the resource is no longer being used by the LSA Licensee/sharing partner) the resource manager 410 then resets the assignment of the resource (which de-assigns the resource) and resets the information access authorization of the resource for the LSA Licensee/sharing partner (which updates the information access authorizations for the resource, e.g., based on change in assignment states for the resource).
F) When a system function (e.g., management system 410) requests a de-assignment of a resource (e.g., such as in a case where the repository 414 or resource manager 416 detects that the maximum time for assignment of the resource has expired), the resource manager 416 performs an evacuation procedure for the resource, e.g., by sending an evacuation message to the currently assigned LSA licensee or sharing partner requesting evacuation of the resource, which may cause the currently assigned Licensee or sharing partner to evacuate or cease use of the resource, and then LSA Licensee/sharing partner sends an evacuation acknowledgement. When the evacuation procedure is finished successfully, e.g., when the currently assigned LSA Licensee/sharing partner has acknowledged the evacuation of the resource, the resource manager 416 resets the assignment and the access authorization for the LSA Licensee to the resource.

5) A scheduler function of the resource manager 416 allows planning of automatic assignment and de-assignment of resources via predefined events. The scheduler distinguishes two different kinds of events: the assignment and the de-assignment. Depending on the event, the scheduler triggers the resource manager 416 to perform step D (above) in case of an assignment event or step F (above) in case of an de-assignment event.

6) In one example implementation, the resource manager 416 may also allow an Incumbent have access to resource information of a resource, e.g., including authorization to retrieve information about the current LSA Licensee/sharing partner which is assigned to a resource. If such retrieval is allowed or not, depends on the sharing scenario/mode (e.g., spectrum pool or mutual renting) and the corresponding access policy for such sharing mode. In one illustrative example, the resource manager 416 may allows an Incumbent to control the owned resource, and have access to the resource information for such resource, without knowledge of the current assigned LSA Licensee/sharing partner.

Mutual Renting:

1) A resource including the associated resource information is initially assigned to a dedicated LSA Licensee A (partner A), e.g., Licensee A/partner A is also granted access to resource information for the resource. Further the Regulator allows a LSA Licensee to rent an initially assigned resource or a part of the initially assigned resource to another LSA Licensee B (Licensee B/partner B). The national Regulator has issued an individual LSA license to each partner/operator (then called LSA Licensee), which allows them to participate at the mutual renting process. The LSA Licenses may distinguish between LSA Licensees who are allowed to offer a resource to others for rent and LSA Licensees who are allowed to rent a resource. When the Licensee A/partner A “mutually rents” a resource to another LSA Licensee B (partner B), the resource is temporary assigned to Licensee B/partner B. Licensees A and B may negotiate additional sharing rules and access authorization definitions for the assignment states initial assignment and temporary assignment of a mutual rented resource in a Sharing Arrangement between Licensee A/partner A and Licensee B/partner B. These additional sharing rules and access authorization definitions are added by Licensee A/partner A to the initial sharing information of the resource. According to an example implementation, initial sharing information may be set for the sharing of resources between an incumbent (spectrum/resource owner) and Licensee A/partner A. The initial sharing information may be extended with sharing information, which may include different spectrum resource definitions and/or additional sharing rules that are valid for sharing between Licensee A and Licensee B, for example. Thus, Licensee A/partner A may provide the following information to the resource manager: (i) information indicating the temporarily assigned resource from Licensee B/partner A to Licensee B/partner B (e.g., including resource definition), (ii) additional sharing rules defined in the bilateral Sharing Arrangement between Licensee A/partner A and Licensee B/partner B, and (iii) the access authorization definitions for each assignment state. In this illustrative example, the assignment state defines whether the resource is currently assigned to Licensee A/partner A (initial assignment) or assigned to Licensee B/partner B (temporary assignment via mutual renting). Further the access authorization is stored either local at the resource manager 416 or external at one or several repositories, such a at repository 414. Additionally, the resource manager 416 may distinguish between initial assignment to Licensee A/partner A and temporary assignment to Licensee B/partner B.

2) The assignment of a resource to Licensee A/partner A or Licensee B/partner B is managed by the resource manager 416. Additionally, the change in assignment state may be used to switch the access authorization to the resource information for Licensee A and Licensee B dynamically based on the access authorization definitions for the assignment state.

3) The following additional management procedures may be part of the resource manager 416 for this illustrative example of mutual renting:
A) Incumbent as resource owner may typically always have access authorization to resource, but not necessarily to the resource information related to the resource that is shared (or rented) from Licensee A/partner A to Licensee B/partner B. Licensee A/partner A and Licensee B/partner B may always access authorization to resource information related to the Sharing Arrangement between Licensee A/partner A and Licensee B/partner B and additional access authorization to the resource according to the prerequisites for the mutual renting.
B) When a resource is marked by the Incumbent as not available to a LSA Licensee/partner, a request from a partner/operator for this resource is rejected by the resource manager 416, the Incumbent and the partner/Licensee to which the resource is initially assigned. Only Licensee A/partner A and Licensee B/partner B may obtain additional (e.g., restricted) information on the resource (e.g. resource is reserved by Incumbent) according to their current access authorization for the resource. For example, when the resource is temporarily assigned by Licensee A/partner A to Licensee B/partner B via mutual renting, there is no technical need for Licensee A to have access authorization to the resource information (such as the resource availability information), e.g., since Licensee A/partner A is aware of the temporary assignment/renting of the resource to Licensee B/partner B (and thus Licensee A is already aware that the resource is currently unavailable).
C) When a resource is not used by Incumbent and not mutually rented by Licensee A/partner A to Licensee B/partner B, the resource is assigned to Licensee A/partner A (in this example). Requests from Licensee A/partner A for this resource and requests from Licensee A for resource information related to the resource are accepted by resource manager 416, while requests from other Operators including Licensee B/partner B for the resource and for some resource information related to the resource may be rejected. In this example, only Licensee A/partner A and Licensee B/partner B may obtain additional (e.g., restricted) resource information related to the resource (e.g., information indicating that the resource is available) according to their current access authorizations defined for the assignment state >>initial assignment<<.
D) When a resource is not used by Incumbent and is mutual rented to Licensee B/partner B, the resource is assigned to Licensee B/partner B. Requests from Licensee B/partner B for this resource are accepted, requests from other Operators including Licensee A/partner A are rejected. Only Licensee A/partner A and Licensee B/partner B will obtain additional (e.g., restricted) resource information related to the resource (e.g., such as availability information indicated that the resource is available) according to their current access authorizations defined for the assignment state >>temporary assignment<<.
E) When the mutual renting expires, step C is initiated by the resource manager 416.
F) When the mutual renting starts, step D is initiated by the resource manager 416.

4) The scheduler function of the resource manager allows planning of dynamic mutual renting via predefined events. The scheduler distinguishes two different kinds of events: the mutual renting start and the mutual renting expiry. Depending on the event, the scheduler triggers the resource manager 416 to perform step E when mutual renting has expired or step F when mutual renting is started.

5) Alternatively Licensee A/partner A may manually start and stop the mutual renting with Licensee B/partner B. This input may be used to trigger resource manager to perform either step D or step C.

6) In one illustrative example, the resource manager 416 may allow an Incumbent to retrieve information about the current Licensee/partner which is assigned to a resource. Whether or not such retrieval is allowed depends on the sharing scenario/mode and the respective access policy that defines information access authorizations for the resource. In one illustrative example, the resource manager 416 allows an Incumbent to control the owned resource without knowledge of the current assigned Licensee/partner, e.g., Licensee/partner information is added by resource manager. In a resource pool or spectrum pool mode of dynamic sharing, a resource may be used by different licensees. The assignment of the resource to a licensee/partner may be managed by the resource manager 416, and the incumbent/owner may have no knowledge about the licensee/partner to which the resource is currently assigned. In special sharing scenarios the incumbent may be allowed to retrieve this information. Therefore, a policy may be used to steer access (including authorizing one or more licensees/partners to access portions of resource information) to various kinds of resource information, including access by incumbents to licensee data/information that belongs to (or associated with) an assignment.

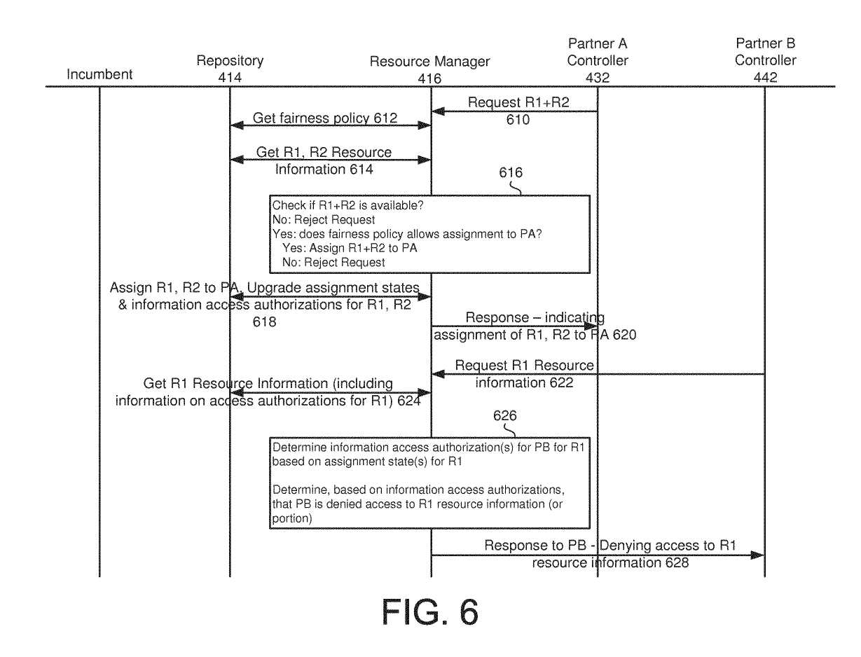

FIG. 6 is a block diagram illustrating operation of a dynamic sharing system 400 for a limited spectrum (or resource) pool mode of dynamic sharing according to an illustrative example implementation. At 610, sharing partner A (or the partner A controller 432) sends a request for resources R1 and R2 to resource manager 416. At 612 and 614, resource manager 416 retrieves the fairness policy and the other resource information for resources R1 and R2 from repository 414. At 616, resource manager 416 determines if R1 and R2 are available, e.g., based on availability information within the resource information, or other parameters within the resource information, for example. If R1 and R2 are not available, then the resource manager 416 sends a rejection back to partner A controller 432, to reject the request. If the requested resources are available, resource manager 416 determines whether the sharing policy, e.g., the fairness policy allows assignment of R1 and R2 to partner A. The request is rejected if the fairness policy does not allow assignment of R1 and R2 to partner A.

At 618, if the fairness policy allows assignment of R1 and R2 to partner A, then the resource manager 416 sends a message to repository 414 to update the assignment state(s) for resources R1 and R2 to assign R1 and R2 to partner A, and to update information access authorizations for R1 and R2 based on the new assignment state. For example, updating the information access authorizations for R1 and R2 may include granting access to partner A for all (or at least a portion) of the resource information for R1 and R2. At 620, resource manager 416 sends a response to the partner A controller 432 indicating that R1 and R2 have been assigned to partner A.

At 622, partner B may send a request for resource information associated with R1. At 624, resource manager 416 may then retrieve resource information from repository 414, e.g., including information access authorizations for R1. At 626, resource manager 416 determines the information access authorizations for R1 (e.g., based on the retrieved information from repository 414, which may include the assignment states for R1, for example). Thus, based on the resource information for R1 retrieved from repository 414, resource manager 416 determines that partner B does not have access (or has been denied access) to the requested resource information (or to one or more requested parameters of the resource information) of R1, since R1 has been assigned to partner A, in this example. Therefore, resource manager 416 determines that partner B is denied access to the resource information (or portion thereof) for resource R1. At 628, resource manager 416 sends a response to partner B indicating that partner B has been denied access to the resource information (or a portion thereof) for R1.

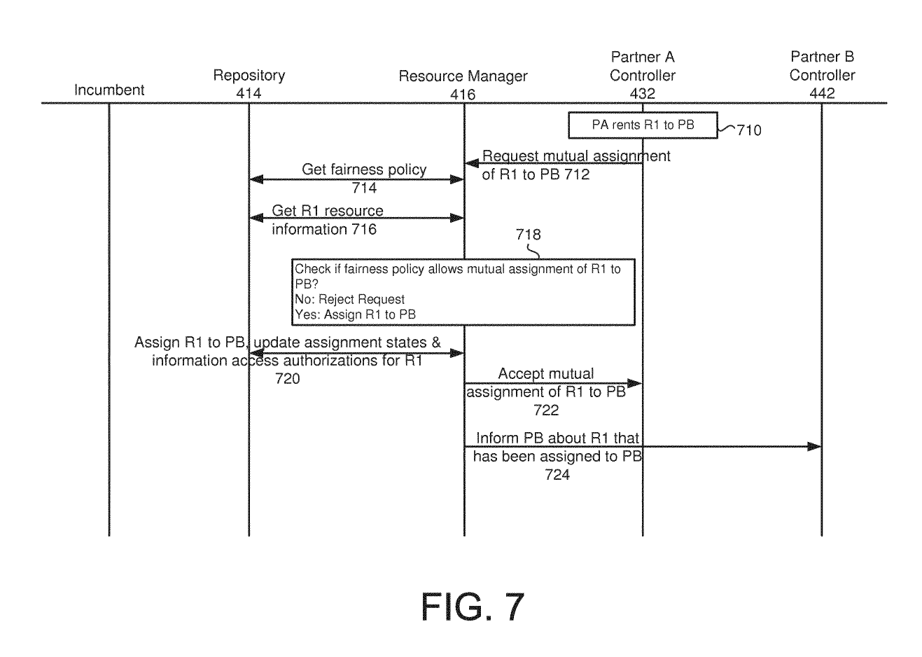

FIG. 7 is a block diagram illustrating operation of a dynamic sharing system 400 for a mutual renting mode of dynamic sharing according to an illustrative example implementation. As shown in FIG. 7, at 710, partner A rents (or temporarily re-assigns) resource R1 to partner B. At 712, partner A may send a request to mutually assign or rent R1 to partner B. At 714 and 716, resource manager 416 retrieve a sharing policy or fairness policy for R1 and other resource information for R1 from repository 414. At 718, resource manager 416 determines is the fairness policy allows renting or temporary reassignment of R1 from partner A to partner B. If the fairness policy does not allow the renting of R1 to partner B, then resource manager 416 sends a message to partner A and/or partner B rejecting the renting or mutual reassignment of R1. In this example, it may be assumed that partner A is otherwise permitted to rent R1 to partner B. Although, in general, additional checks may be performed by resource manager regarding the renting of R1 if such further permissions or renting authorizations are required, for example.

If renting of R1 is permitted, then, at 720, resource manager 416 may send a message to repository 414 assigning R1 to partner B, to update the assignment states, and to update the information access authorizations for R1, e.g., as this information may be stored in repository 414 and updated upon command or request from resource manager 416.

Next, if the fairness policy allows renting of R1 to partner B, at 722 the resource manager 416 sends a message to partner A and/or partner B accepting the renting or mutual assignment of R1 to partner B. At 724, partner A may forward or send a message to partner B indicating the renting or mutual assignment of R1 to partner B has been approved or authorized, or that R1 has been rented or temporarily assigned to partner B, for example. FIGS. 6 and 7 merely describe some illustrative examples, and other messages or operations may be used.

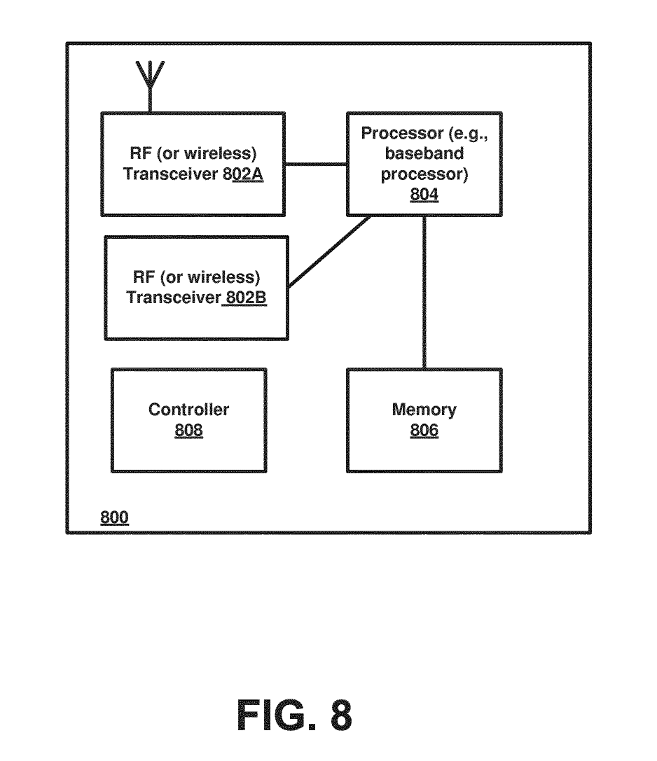

FIG. 8 is a block diagram of a wireless station (e.g., BS or user device) 800 according to an example implementation. The wireless station 800 may include, for example, two RF (radio frequency) or wireless transceivers 802A, 802B, where each wireless transceiver includes a transmitter to transmit signals and a receiver to receive signals. The wireless station also includes a processor or control unit/entity (controller) 804 to execute instructions or software and control transmission and receptions of signals, and a memory 806 to store data and/or instructions.

Processor 804 may also make decisions or determinations, generate frames, packets or messages for transmission, decode received frames or messages for further processing, and other tasks or functions described herein. Processor 804, which may be a baseband processor, for example, may generate messages, packets, frames or other signals for transmission via wireless transceiver 802 (802A or 802B). Processor 804 may control transmission of signals or messages over a wireless network, and may control the reception of signals or messages, etc., via a wireless network (e.g., after being down-converted by wireless transceiver 802, for example). Processor 804 may be programmable and capable of executing software or other instructions stored in memory or on other computer media to perform the various tasks and functions described above, such as one or more of the tasks or methods described above. Processor 804 may be (or may include), for example, hardware, programmable logic, a programmable processor that executes software or firmware, and/or any combination of these. Using other terminology, processor 804 and transceiver 802 together may be considered as a wireless transmitter/receiver system, for example.

In addition, referring to FIG. 8, a controller (or processor) 808 may execute software and instructions, and may provide overall control for the station 800, and may provide control for other systems not shown in FIG. 8, such as controlling input/output devices (e.g., display, keypad), and/or may execute software for one or more applications that may be provided on wireless station 800, such as, for example, an email program, audio/video applications, a word processor, a Voice over IP application, or other application or software.

In addition, a storage medium may be provided that includes stored instructions, which when executed by a controller or processor may result in the processor 804, or other controller or processor, performing one or more of the functions or tasks described above.

According to another example implementation, RF or wireless transceiver(s) 802A/802B may receive signals or data and/or transmit or send signals or data. Processor 804 (and possibly transceivers 802A/802B) may control the RF or wireless transceiver 802A or 802B to receive, send, broadcast or transmit signals or data.

According to an example implementation, resource manager 416 and/or repository 414 may include a processor 804, a controller 808, memory 806, input/output devices (not shown), one or more network interfaces (not shown), and other computer hardware and/or software which may be provided on a computer, server or other computing device. According to one illustrative example implementation, resource manager 416 and/or repository 414 may each include software running on a computer, server, or other computing device, where the computing device may include a processor 804, a controller 808, a memory 806, etc. Also, in another example implementation, a host, computing node or server (which may include all or part of the functionality of repository 414 and/or resource manager 416) may be coupled (e.g., operationally coupled) to a remote radio head, one or more BSs, and/or other wireless infrastructure, or infrastructure associated with one or more sharing partners.

An example of an apparatus may also include means (e.g., 804 or 808) for determining a change in an assignment state for the network resource that is shared among a plurality of sharing partners, and means (e.g., 804 or 808) for determining, for one or more of the sharing partners, information access authorization for access to the resource information related to the network resource based on the determining the change in assignment state for protecting the resource information.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-34. (canceled)

35. A method comprising:
determining a change in an assignment state for a network resource that is shared among a plurality of sharing partners in a wireless network; and
determining, for one or more of the sharing partners, information access authorization for access to the resource information related to the network resource based on the determining the change in assignment state for protecting the resource information.

36. The method of claim 35, wherein the determining information access authorization comprises:
determining, for one or more sharing partners based on an access policy, an information access authorization for access to one or more parameters of the resource information based on the determined change in assignment state.

37. The method of claim 35, wherein the determining a change in assignment state comprises determining that the network resource has been assigned to a first sharing partner; and
wherein the method further comprising:
granting access to the first sharing partner to both basic information and restricted information of the resource information;
denying access to one or more other sharing partners to at least the restricted information of the resource information.

38. The method of claim 35, wherein the determining a change in assignment state comprises:
de-assigning the network resource to a first sharing partner and re-assigning the network resource to a second sharing partner; and
wherein the determining information access authorization comprises determining that the second sharing partner is authorized to access at least a portion of the resource information and determining that the first sharing partner is not authorized to access at least a portion of the resource information; and
wherein the method further comprising:
denying access to at least a portion of the resource information to the first sharing partner; and
granting access to at least a portion of the resource information to the second sharing partner.

39. The method of claim 35, wherein the determining a change in assignment state comprises:
receiving an indication from a first sharing partner that the first sharing partner has rented or temporarily assigned the network resource to a second sharing partner;
wherein the determining information access authorization comprises determining that the first sharing partner is not authorized to access at least a portion of the resource information and determining that the second sharing partner is authorized to access at least a portion of the resource information; and
wherein the method further comprises one or more of the following:
denying access to at least a portion of the resource information to the first sharing partner; and
granting access to at least a portion of the resource information to the second sharing partner.

40. The method of claim 35, wherein an access policy is provided for each of a plurality of sharing modes including a first access policy associated with a first sharing mode and a second policy associated with a second mode, wherein the determining information access authorization comprises:
determining that the first sharing mode is used for sharing the network resource among the plurality of sharing partners;
determining that the first access policy is associated with the first sharing mode;
determining, for one or more sharing partners based on the first access policy, information access authorization for the access of the resource information based on the determined change in assignment state

41. The method of claim 35, wherein a resource pool mode is used to share the network resource among the plurality of sharing partners, wherein the determining a change in assignment state comprises at least one of:
assigning the network resource to a first sharing partner; and
de-assigning the network resource from the first sharing partner.

42. The method of claim 35, wherein the determining a change comprises:
receiving a fairness policy for the assignment of the network resource;
receiving, by a resource manager from a first partner, a request for the resource;
retrieving the information related to the network resource;
determining that the network resource is available;
determining that the fairness policy allows assignment of the network resource to the first partner; and
sending, from the resource manager to the first partner, a response indicating that the network resource has been assigned to the first partner.

43. The method of claim 35, wherein the determining a change comprises:
receiving an indication from a first partner that the first partner has rented or temporarily assigned the network resource to a second partner.

44. An apparatus comprising at least one processor and at least one memory including computer instructions, when executed by the at least one processor, cause the apparatus to:
determine a change in an assignment state for a network resource that is shared among a plurality of sharing partners in a wireless network; and
determine, for one or more of the sharing partners, information access authorization for access to the resource information related to the network resource based on the determining the change in assignment state for protecting the resource information.

45. The apparatus of claim 44, wherein the instructions causing the apparatus to determine information access authorization comprises the instructions cause the apparatus to:
determine, for one or more sharing partners based on an access policy, an information access authorization for access to one or more parameters of the resource information based on the determined change in assignment state.

46. The apparatus of claim 44, wherein the instructions causing the apparatus to determine a change in assignment state comprises the instructions cause the apparatus to determine that the network resource has been assigned to a first sharing partner; and
wherein the instructions further cause the apparatus to:
grant access to the first sharing partner to both basic information and restricted information of the resource information; and
deny access to one or more other sharing partners to at least the restricted information of the resource information.

47. The apparatus of claim 44, wherein the instructions causing the apparatus to determine a change in assignment state comprises the instructions cause the apparatus to:
de-assign the network resource to a first sharing partner and re-assigning the network resource to a second sharing partner; and
wherein the instructions causing the apparatus to determine information access authorization comprises instructions cause the apparatus to determine that the second sharing partner is authorized to access at least a portion of the resource information and determine that the first sharing partner is not authorized to access at least a portion of the resource information; and
wherein the instructions further cause the apparatus to:
deny access to at least a portion of the resource information to the first sharing partner; and
grant access to at least a portion of the resource information to the second sharing partner.

48. The apparatus of claim 44, wherein the instructions causing the apparatus to determine a change in assignment state comprises the instructions causing the apparatus to:
receive an indication from a first sharing partner that the first sharing partner has rented or temporarily assigned the network resource to a second sharing partner;
wherein the instructions causing the apparatus to determine information access authorization comprises the instructions cause an apparatus to determine that the first sharing partner is not authorized to access at least a portion of the resource information and determine that the second sharing partner is authorized to access at least a portion of the resource information; and
wherein the instructions cause the apparatus to perform one or more of the following:
deny access to at least a portion of the resource information to the first sharing partner; and
grant access to at least a portion of the resource information to the second sharing partner.

49. The apparatus of claim 44, wherein an access policy is provided for each of a plurality of sharing modes including a first access policy associated with a first sharing mode and a second policy associated with a second mode, wherein the instructions causing the apparatus to determine information access authorization comprises instructions that cause the apparatus to:
determine that the first sharing mode is used for sharing the network resource among the plurality of sharing partners;
determine that the first access policy is associated with the first sharing mode; and
determine, for one or more sharing partners based on the first access policy, information access authorization for the access of the resource information based on the determined change in assignment state.

50. The apparatus of claim 44, wherein a resource pool mode is used to share the network resource among the plurality of sharing partners, wherein the instructions that cause the apparatus to determine a change in assignment state comprises instructions that cause the apparatus to perform at least one of:
assign the network resource to a first sharing partner; and
de-assign the network resource from the first sharing partner.

51. The apparatus of claim 44, wherein the instructions that cause the apparatus to determine a change comprises instructions that cause the apparatus to:
receive a fairness policy for the assignment of the network resource;
receive, by a resource manager from a first partner, a request for the resource;
retrieve the information related to the network resource;
determine that the network resource is available;
determine that the fairness policy allows assignment of the network resource to the first partner; and
send, from the resource manager to the first partner, a response indicating that the network resource has been assigned to the first partner.

52. The apparatus of claim 44, wherein the instructions that cause the apparatus to determine a change comprises instructions that cause the apparatus to:
receive an indication from a first partner that the first partner has rented or temporarily assigned the network resource to a second partner.

53. A computer program product, the computer program product comprising a non-transitory computer-readable storage medium storing executable code that, when executed by at least one data processing apparatus, is configured to cause the at least one data processing apparatus to perform a method comprising:
determining a change in an assignment state for a network resource that is shared among a plurality of sharing partners in a wireless network; and
determining, for one or more of the sharing partners, information access authorization for access to the resource information related to the network resource based on the determining the change in assignment state for protecting the resource information.

54. The computer program product of claim 53, wherein determining information access authorization further comprises:
determining, for one or more sharing partners based on an access policy, an information access authorization for access to one or more parameters of the resource information based on the determined change in assignment state.
